(19) United States
(12) Patent Application Publication
(10) Pub. No.: US 2026/0254487 A1
(43) Pub. Date: Aug. 27, 2026

(54) VIRTUAL DISTRIBUTED ANTENNA SYSTEM

(71) Applicant: JOHN MEZZALINGUA ASSOCIATES, LLC., Liverpool, NY (US)

(72) Inventors: Giulio GABELLI, Bologna (IT); Massimo NOTARGIACOMO, Castel Bolognese (IT); Daniel MORELLI, Georgetown, TX (US)

(21) Appl. No.: 19/545,976

(22) Filed: Feb. 20, 2026

Related U.S. Application Data
(60) Provisional application No. 63/761,559, filed on Feb. 21, 2025.

(51) Int. Cl. H04B 7/0456; H04W 72/0446; H04W 72/0453

(52) U.S. Cl. CPC H04B 7/0456; H04W 72/0446; H04W 72/0453

(57) ABSTRACT

A Virtual DAS has a plurality of Virtual Active Antenna System (V-AAS) that is coupled to a plurality of O-RUs, and to a plurality of O-DUs that are geographically distributed. Each V-AAS converts Category B data from one of the plurality of O-DUs, converts the multiple layers of time domain I/Q samples within the Category B data into a plurality of Category A data that it transmits to the plurality of O-RUs. In doing so, the Virtual DAS converts Massive MIMO Category B data intended for a single O-RU into Category A data that it sends to the plurality of geographically distributed O-RUs.

### CROSS-REFERENCE TO RELATED APPLICATION

This application claims the benefit of U.S. Provisional Application No. 63/761,559, filed February 21, 2025, which is hereby incorporated by reference in its entirety.

### BACKGROUND OF THE INVENTION

A conventional Distributed Antenna System (DAS) has a master unit that is connected to a plurality of analog remote units over an analog RF (Radio Frequency) connection. One or more base stations may be connected to the master unit over RF analog connections.

A disadvantage of a conventional DAS is that its capacity (e.g., number of connected UEs (User Equipment) per area is limited, and fixed. Conventional approaches to increase capacity involve “cell splitting,” which leads to high inter-cell interference and frequent handovers between the cells.

An advantage of a conventional DAS is that it may have antennas that are dispersed over a wide area, assuring coverage in complex deployments, such as stadiums, hospitals, airports, or dense urban areas.

Conventional Massive MIMO (Multiple Input Multiple Output) Radio Access Networks (RAN) have a base station, which may have a Centralized Unit (CU) and a Distributed Unit (DU), whereby the DU may be connected to multiple Remote Units (RUs) over a packetized Ethernet network. In a Massive MIMO RAN, the RUs may have an antenna array that may be as complex as a 64x64 array. Such a deployment enables many UEs to be connected to the RU via beamforming, whereby spectrum resources may be shared among UEs that are spatially separated. A downside of a Massive MIMU RAN is its complexity, and that its coverage area may be limited.

Accordingly, what is needed is a RAN that offers the large and high-quality coverage area while providing the flexibility and scalable capacity of a Massive MIMO RAN.

### SUMMARY OF THE INVENTION

The present disclosure involves a method for operating a V-DAS (Virtual-Distributed Antenna System) having a V-POI (Virtual Point of Interface) that is coupled to a plurality of O-RUs (Open Radio Access Network – Remote Units). The method includes receiving Category B data from an O-DU (Open Radio Access Network – Distributed Unit) and performing Category B lower PHY (Physical Layer) processing on the Category B data to generate a set of modulated frequency domain data. The method then involves applying a precoding matrix to the set of modulated frequency domain data to generate Category A data, and transmitting the Category A data to a subset of the O-RUs.

Another aspect of the disclosure involves a method for operating a V-DAS (Virtual-Distributed Antenna System) having a V-POI (Virtual Point of Interface) that is coupled to a plurality of O-RUs (Open Radio access Network – Remote Units). This method includes receiving Category A data from each of the plurality of O-RUs and deriving, from the Category A data, channel state information corresponding to each of a plurality of UEs (User Equipment), each of the plurality of UEs connected to a subset of the plurality of O-RUs corresponding to each individual one of the plurality of UEs. The method also includes generating a precoding matrix corresponding to the channel state information and generating a different set of I/Q (In-phase/Quadrature) data corresponding to each of the plurality of UEs from the Category A data. Each of the different sets of I/Q data are then converted into Category B data, and the Category B data is then transmitted to an O-DU (Open Radio Access Network – Distributed Unit).

### BRIEF DESCRIPTION OF DRAWINGS

FIG. 1 illustrates an exemplary Virtual DAS deployment according to the disclosure.

FIG. 2 illustrates an exemplary Virtual DAS deployment, showing an example physical distribution of the Remote Units and how they may be connected to a plurality of UEs.

FIG. 3 illustrates an exemplary process for implementing a Virtual Active Antenna System according to the disclosure.

### DETAILED DESCRIPTION OF THE INVENTION

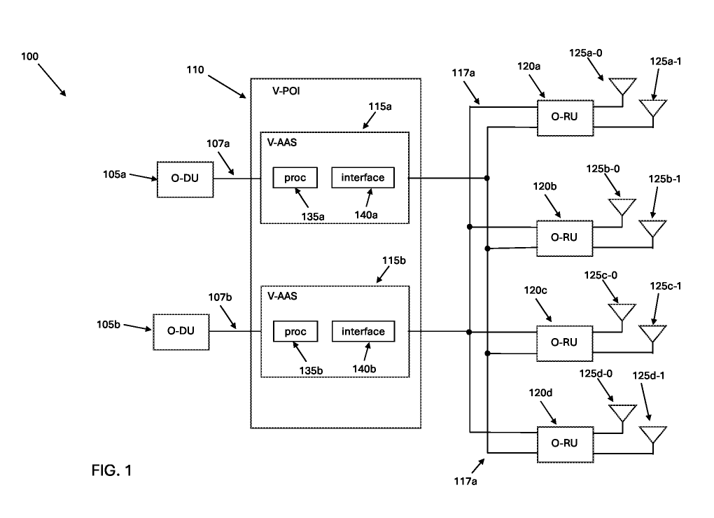

FIG. 1 illustrates an exemplary Virtual DAS 100 deployment according to the disclosure. Virtual DAS deployment 100 may be implemented according to the O-RAN (Open-RAN) standard. Virtual DAS 100 has a Virtual Point of Interface (V-POI) 110, which may be coupled to one or more O-DUs (Open RAN DU) 105a and 105b, each of which may host one or more different mobile network operators. V-POI 110 may host or more Virtual Active Antenna Systems (V-AAS) 115a and 115b. Each V-AAS 115a/b may be coupled to its corresponding O-DU 105a/b over a respective Category B 7.2x interface 107a/b. Category B 7.2x interfaces 107a/b are illustrated as logical connections. It will be understood that these logical connections may be over a single physical Ethernet network.

As used herein, a reference to a specific component (e.g., V-AAS 115a, O-RU 120c, etc.) will have its lower case letter designator. For any discussion about a common feature of a given component, the letter designator may be absent. In other words, a description of V-AAS 115 applies to either/both of V-AAS 115a/b.

Each V-AAS 115a/b is coupled to a plurality of O-RUs 125a-d over a respective Category A 7.2x interface 117a/b. Category A 7.2x interfaces 117a/b are illustrated as logical connections. It will be understood that these logical connections may be over a single physical Ethernet network. The Ethernet network may have one or more Ethernet switches, or may be implemented as a point-to-point Ethernet link.

Each V-AAS 115 has a processor module 135 and an interface module 140. Processor module 135 processes downlink data from O-DU 105 and processes uplink data from each O-RU 120. For the downlink data, processor module 135 translates the compressed time domain Category B 7.2x data into an array of frequency domain I/Q samples, one per endpoint (defined below), that it provides to interface module 140 for mapping to the O-RUs 120a-d, using an exemplary process that is described below. For the uplink data, processor module 130 receives Category A 7.2x data from the O-RUs 120a-d via interface module 140, performs PHY layer processing that would otherwise be performed by an O-DU under Category A, converts the data into compressed time domain packetized data, and transmits the Category B 7.2x data to corresponding O-DUs 105.

Each O-RU 120 may have a plurality of antennas 125 (e.g., 2, 4, 8, etc.) . In the illustrated example, O-RU 120a has antennas 125a-0 and 125a-1; O-RU 120b has antennas 125b-0 and 125b-1; O-RU 120c has antennas 125c-0 and 125c-1; and O-RU 120d has antennas 125d-0 and 125d-1.

Each O-RU 120 may perform Category A lower PHY (Physical) layer functions as specified in the O-RAN specification. In addition, each O-RU 120 has a separate processing path (not shown) for each of its antennas 125, and for each component carrier that is to be transmitted/received over that antenna. Accordingly, each O-RU 120 / component carrier / antenna combination may be referred to as an endpoint. Each component carrier may be dedicated to a particular O-DU 105a/b and may have a center frequency that falls within the licensed spectrum of its mobile network operator, or may be within an unlicensed spectrum or shared spectrum frequency range. It will be understood that such variations are possible and within the scope of the disclosure. Accordingly, each O-RU 120 may process component carriers for both O-DUs 105, and each O-DU 105a/b may interact with every O-RU 120a-d. In other words, each mobile network operator may have one or more unique assigned endpoints within each O-RU 120.

As used herein, the term “software module” or “module” may refer to a set of machine-readable instructions that are encoded within one or more non-transitory memory devices and executed on one or more processors that host the referenced component. The referenced components that might involve processors that run software modules as defined herein include V-POI 110; V-AASs 115a/b and constituent processor 135a/b and interface 140a/b; and the embedded software components of O-RUs 120a-d. As used herein, the term “non-transitory memory” may refer to any tangible storage medium (as opposed to an electromagnetic or optical signal) and refer to the medium itself, and not to a limitation on data storage (e.g., RAM vs. ROM). For example, non-transitory medium may refer to an embedded memory that is encoded with instructions whereby the memory may have to be re-loaded with the appropriate machine-readable instructions after being power cycled. Further, if an action is described herein as being done by a referenced module (e.g., “V-AAS 115a receives Category B 7.2x data from O-RU 105a”), it will be understood that this may describe one or more processors executing the module’s machine-readable instructions to perform that particular action. Further, the processors that execute instructions the above-listed modules may be servers or embedded processors. Also, as used herein, the term “processor” may refer to one or more microprocessors or FPGAs (Field Programmable Gate Array).

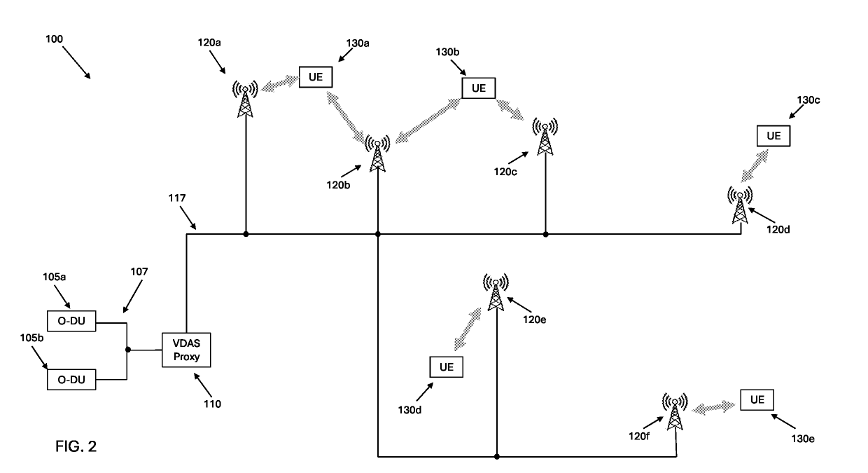

FIG. 2 illustrates exemplary Virtual DAS 100 deployment, showing an example physical distribution of the Remote Units and how they may be connected to a plurality of UEs. O-RUs 120 may be physically distributed over an area that may encompass many square kilometers and may include dozens or even hundreds of O-RUs 120. Accordingly, any given UE 130 may only be connected to a small subset of O-RUs 120. In the illustrated example, UE 130a is connected to O-RU 120a and 120b; and UE 130b is connected to O-RU 120b and 120c. The remaining UEs are only connected to a single O-RU 120. It will be understood that each O-RU 120 in the illustration has two antennas (not shown), so that each UE 130 may be engaged in 2x2 MIMO with the O-RU(s) to which it is connected.

Variations to Virtual DAS 100 deployment are possible. For example, any of the O-RUs 120 may have four antennas (not shown), and thus may engage in 4x4 MIMO communications with the UE 130 connected to it. Other antenna combinations (e.g, 8x8, 16x16, etc.) are possible. It will be understood that such variations are possible and within the scope of the disclosure.

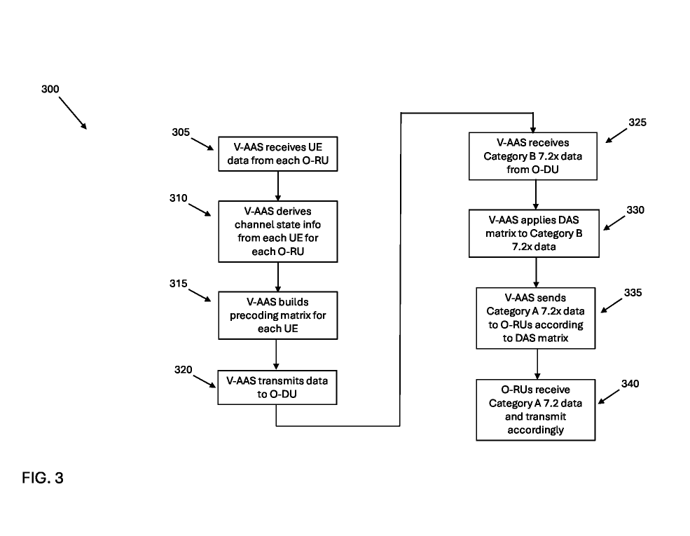

FIG. 3 illustrates an exemplary process 300 for operating a Virtual DAS 100 according to the disclosure. Although the process is described with reference to V-AAS 120 and O-DU 105, it will be understood that this applies to either/both of V-AAS 120a/b and O-DU 105a/b. In this example, O-RU 120f has four antennas and thus 4x4 MIMO capability; and the other O-RUs 120a-e have two antennas and thus 2x2 MIMO capability.

In step 305, processor module 135 in V-AAS 115 receives Category A 7.2x uplink data from each O-RU 120a-d via its interface module 140. This data includes frequency domain uplink I/Q samples from each UE 130 connected to the given endpoint (component carrier, antenna, O-RU 120). In the illustrated example of FIG. 2, O-RU 120a sends Category A 7.2x uplink data for UE 130a for both antenna 120a-0 and antenna 120a-1; O-RU 120b sends Category A 7.2x uplink data for UE 130a for both antenna 120b-0 and antenna 120b-1, and for UE 130b for both antenna 120b-0 and antenna 120b-1; O-RU 120c sends Category A 7.2x uplink data for UE 130b for both antenna 120c-0 and antenna 120c-1; O-RU 120d sends Category A 7.2x uplink data for UE 130c for both antenna 120d-0 and antenna 120d-1; O-RU 120e sends Category A 7.2x uplink data for UE 130d for both antenna 120e-0 and antenna 120e-1; and O-RU 120f sends Category A 7.2x uplink data for UE 130e both antenna 120f-0, antenna 120f-1, antenna 120f-2, and antenna 120f-3.

In step 310, processor module 135 in V-AAS 115 processor module 135 derives channel state information from the uplink Category A 7.2x uplink data for each UE 130. This may be done using conventional methods.

In step 315, processor module 135 uses the channel state information to build a precoding matrix for each UE 130. Given the physical dispersion of the O-RUs 120, only a subset of O-RUs 120 may be receiving a signal from a given UE 130. Accordingly, processor module 135 may build a precoding matrix for each UE using I/Q samples from the subset of O-RUs 120 to which the given UE 120 is connected. The remaining O-RU 120 signals may be zeroed out for that particular UE 120.

Referring to FIG. 2, for example, the signal strength for UE 130a may be zeroed out in the matrix elements corresponding to the four antennas of O-RU 120f, the two antennas of O-RU 120e, the two antennas of O-RU 120d, and the two antennas of O-RU 120c. However, the signal strength for UE 130a may be preserved in the matrix elements corresponding to the two antennas of O-RU 120a and O-RU 120b. This is reflected in the generated precoding matrix.

Further to step 315, processor module 135 may then generate a single set of I/Q data for each UE 130 by multiplying the incoming data sets for the given UE 130 by the precoding matrix.

In step 320, processor module 135 demodulates and converts the frequency domain data set generated in step 315 into the time domain, and may compress the time domain data as specified for Category B. V-AAS 115 then transmits the newly-generated Category B 7.2x data to O-DU 105.

In step 325, V-AAS 115 receives downlink Category B 7.2x data from O-DU 105. This is time domain I/Q samples in multiple layers. For example, a Massive MIMO system with 64T64R (64 Transmit, 64Receive) requires a matrix of 16 layers from O-DU 105, which is sent to V-AAS 115 with the intention of implementing beamforming. This is an example, and other layer combinations may be used, depending on the complexity of the intended beamforming.

In step 330, processor module 135 within V-AAS 115 performs the PHY layer functions implemented by a Category B O-RU, including conversion into the frequency domain and OFDM (Orthogonal Frequency Division Multiplexing). Processor module 135 then applies the precoding matrix generated in step 315 to the layers received from the O-DU 105 in step 325. In doing so, processor module 135 maps the layers to endpoints. In doing so, processor module 135 multiplies the incoming converted I/Q data for a given UE 130 by its precoding matrix generated in step 315, generating a Category A 7.2x data set.

One may note that, given that the given UE is only connected to a subset of all the O-RUs, this information is reflected in the precoding matrix. Accordingly, processor 135 may send only the non-zero resulting I/Q sample sets to interface 140 for transmission to their respective endpoints.

In step 335, interface module 145 within V-AAS 115 sends the Category A 7.2x data corresponding to each UE 130 to its respective endpoint. In doing so, it may only transmit data for those UEs 130 and their corresponding O-RUs 120, component carriers, and antennas 125, that were not zeroed out in generating the precoding matrix in step 315.

In step 340, each O-RU 120 receives its Category A 7.2x data, performs lower PHY layer processing on the data, and transmits it accordingly.

Depending on the configuration and topology of the O-RUs 120, processor module 135 may map the 64T64R to 32radios that do 2x2 MIMO, or 16 radios that do 4x4 MIMO, or some combination of these.

An advantage of the disclosed system and process is that, by only transmitting Category A 7.2 data to those endpoints associated with a strong signal, the other endpoints of the same component carrier then become available for simultaneous use by other UEs 130. This may enable flexible and expandable capacity.

In the example of FIG. 2, under the disclosed system, UE 130a may be served simultaneously be antennas 120a-0 and 120a-1 of O-RU 120, and antennas 120b-0 and 120b-1 of O-RU 120b, while the component carriers used by UE 130a may be simultaneously used by UE 130e (via O-RU 120f) and/or UE 130c (via O-RU 120d).

By implementing the disclosed V-AAS, instead of implementing 64x64 Massive MIMO from a single location, the sixty-four signals may instead be spatially distributed among O-RUs covering a broad physical area. This may allow a single cell to cover a much greater area, and by taking advantage of spectrum reuse, may allow scalability so that the single cell of much greater area may also have enhanced capacity.

Massive MIMO operates whereby all of the signals from O-DU 105 would go to a single O-RU, which would have all the radios and antennas (e.g., 64 ports) to operate under 64T64R. Accordingly, all of the signals follow the same physical path from the O-DU to the O-RU. This is not the case with the disclosed Virtual DAS 100, whereby the signals may be split and sent to O-RUs that are physically distributed. These different path lengths lead to a phase coherence challenge in that the phase differences must either be eliminated (by precise synchronization between O-RUs 120, or by measuring and compensating for the phase differences between them. In the former case, existing network synchronization protocols, such as Network Time Protocol (NTP), Simple Network Time Protocol (SNTP), Precision Time Protocol (PTP), or GPS may be used. In the latter case, processor module 135 may implement a signal correlation scheme to measure the phase differences between incoming correlated signals and measuring their relative phase differences. This may be done through an Artificial Intelligence implementation that dynamically identifies phase differences between signals coming from neighboring O-RUs 120. Such an approach may enable processor module 135 to build a phase compensation matrix that may be used like a codebook for applying phase compensation to the Category B 7.2x data from the O-DU 105 to the Category A 7.2x data to be transmitted to the O-RUs 120.

1. A method for operating a V-DAS (Virtual-Distributed Antenna System) having a V-POI (Virtual Point of Interface) that is coupled to a plurality of O-RUs (Open Radio access Network – Remote Units), the method comprising:
receiving Category B data from an O-DU (Open Radio Access Network – Distributed Unit);
performing a Category B lower PHY (Physical Layer) processing on the Category B data to generate a set of modulated frequency domain data;
applying a precoding matrix to the set of modulated frequency domain data to generate Category A data; and
transmitting the Category A data to a subset of the O-RUs.

2. The method of claim 1, wherein the Category B data comprises multi-layer I/Q time domain data samples.

3. The method of claim 1, wherein the generated set of modulated frequency domain data is OFDM (Orthogonal Frequency Division Multiplexing) data.

4. The method of claim 1, wherein applying the precoding matrix to the set of modulated frequency domain data to generate a Category A data comprises:
multiplying the generated frequency domain data by one or more values of the precoding matrix to generate corresponding one or more Category A data sets.

5. The method of claim 4, wherein transmitting the Category A data to the subset of the O-RUs comprises:
transmitting each of the one or more Category A data sets to a UE via the subset of O-RUs to which the UE is connected.

6. The method of claim 5, wherein transmitting each of the one or more Category A data sets to a UE via the subset of O-RUs to which the UE is connected comprises:
transmitting each of the one or more Category A data sets to the UE via a corresponding one or more endpoints,
wherein each endpoint is defined by a unique combination of one O-RU of the subset of O-RUs, one antenna associated with the one O-RU, and one component carrier, and
wherein each of the one or more endpoints maps to a corresponding one of the one or more values of the precoding matrix.

7. The method of claim 6,
wherein the precoding matrix includes both zero and non-zero values, and
wherein each of the one or more values of the precoding matrix to which the one or more endpoints are mapped is a non-zero value.

8. A method for operating a V-DAS (Virtual-Distributed Antenna System) having a V-POI (Virtual Point of Interface) that is coupled to a plurality of O-RUs (Open Radio access Network – Remote Units), comprising;
receiving Category A data from each of the plurality of O-RUs;
deriving, from the Category A data, channel state information corresponding to each of a plurality of UEs (User Equipment), each of the plurality of UEs connected to a subset of the plurality of O-RUs corresponding to each individual one of the plurality of UEs;
generating a precoding matrix corresponding to the channel state information;
generating a different set of I/Q (In-phase/Quadrature) data corresponding to each of the plurality of UEs from the Category A data;
converting each of the the different sets of I/Q data into Category B data; and
transmitting the Category B data to an O-DU (Open Radio Access Network – Distributed Unit).

9. The method of claim 8 further comprising:
receiving Category B data associated with one of the plurality of UEs from an O-DU;
performing Category B lower PHY (physical layer) processing on the Category B data associated with the one UE to generate a set of modulated frequency domain data associated with the one UE;
applying the precoding matrix to the set of modulated frequency domain data to generate Category A data associated with the one UE; and
transmitting the Category A data to a subset of the O-RUs to which the one UE is connected.

10. The method of claim 9, wherein applying the precoding matrix to the set of modulated frequency domain data to generate the Category A data associated with the one UE comprises:
multiplying the generated frequency domain data by one or more values of the precoding matrix to generate corresponding one or more Category A data sets associated with the one UE.

11. The method of claim 10, wherein transmitting the Category A data to the subset of the O-RUs to which the UE is connected comprises:
transmitting each of the one or more Category A data sets to the one UE via a corresponding one or more endpoints,
wherein each endpoint is defined by a unique combination of one O-RU of the subset of O-RUs to which the one UE is connected, one antenna associated with the one O-RU, and one component carrier, and
wherein each of the one or more endpoints maps to a corresponding one of the one or more values of the precoding matrix.

12. The method of claim 11,
wherein the precoding matrix includes both zero and non-zero values, and
wherein each of the one or more values of the precoding matrix to which the one or more endpoints are mapped is a non-zero value.

13. A Virtual Point of Interface (V-POI) for a virtual distributed antenna system, the V-POI comprising:
a processor; and
an interface in communication with a plurality of O-RUs,
wherein the interface is configured to receive Category A data from each of the plurality of O-RUs; and
wherein the processor is configured to:
derive channel state information corresponding to each of a plurality of UEs (User Equipments), each of the plurality of UEs connected to a subset of the plurality of O-RUs corresponding to each individual one of the plurality of UEs,
generate a precoding matrix corresponding to the channel state information,
generate a different set of I/Q (In-phase/Quadrature) data corresponding to each of the plurality of UEs from the Category A data,
convert each of the the different sets of I/Q data into Category B data, and
transmit the Category B data to an O-DU (Open Radio Access Network – Distributed Unit).

14. The V-POI of claim 13, wherein the processor is further configured to:
receive Category B data associated with one of the plurality of UEs from an O-DU,
perform Category B lower PHY (physical layer) processing on the Category B data associated with the one UE to generate a set of modulated frequency domain data associated with the one UE, and
apply the precoding matrix to the set of modulated frequency domain data to generate a Category A data associated with the one UE, and
wherein the interface is further configured transmit the Category A data to a subset of the O-RUs to which the one UE is connected.

15. The V-POI of claim 14, wherein the processor is further configured to multiply the generated set of frequency domain data by one or more values of the precoding matrix to generate a corresponding one or more Category A data sets associated with the one UE.

16. The V-POI of claim 15,
wherein the interface is further configured to transmit each of the one or more Category A data sets to the one UE via a corresponding one or more endpoints,
wherein each endpoint is defined by a unique combination of one O-RU of the subset of O-RUs to which the one UE is connected, one antenna associated with the one O-RU, and one component carrier, and
wherein each of the one or more endpoints maps to a corresponding one of the one or more values of the precoding matrix.

17. The method of claim 16,
wherein the precoding matrix includes both zero and non-zero values, and
wherein each of the one or more values of the precoding matrix to which the one or more endpoints are mapped is a non-zero value.
